(19) United States
(12) Patent Application Publication
(10) Pub. No.: US 2023/0191828 A1
(43) Pub. Date: Jun. 22, 2023

(54) WALL MOUNTING ATTACHMENT DEVICE

(71) Applicant: Travis Breiner, Sugar Hill, GA (US)

(72) Inventor: Travis Breiner, Sugar Hill, GA (US)

(21) Appl. No.: 17/949,448

(22) Filed: Sep. 21, 2022

Related U.S. Application Data
(60) Provisional application No. 63/291,491, filed on Dec. 20, 2021.

(51) Int. Cl. B44C 5/02; F16B 47/00; A47G 1/16

(52) U.S. Cl. CPC B44C 5/02; F16B 47/003; A47G 1/1606

(57) ABSTRACT

A wall mounting apparatus including a first prism and a second prism. The first prism includes a first surface and a second surface, the first surface being parallel to the second surface. The first surface further includes a first aperture extending through the first surface and the second surface. The shape of the first aperture can include a semicircular arch. The second prism comprising a third surface and a fourth surface, the third surface being parallel the fourth surface. The fourth surface of the second prism may mount to the first surface of the first prism. The second prism may include a second aperture extending through the third surface and the fourth surface. The second aperture may include an elongated shape configured to form a locking interface.

### CROSS REFERENCE TO RELATED APPLICATIONS

This application claims the benefit of, and priority to, U.S. Provisional Patent Application. No. 63/291,491, filed on Dec. 20, 2021, and entitled “WALL MOUNTING ATTACHMENT DEVICE,” the disclosure of which is incorporated by reference herein in its entirety.

### TECHNICAL FIELD

The present apparatuses, systems, and methods relate generally to mounting systems and, more particular, to wall mounting devices for wall decorations and hangable objects.

### BACKGROUND

Wall decorations have been a staple of many interior design projects. Paintings, sculptures, artifacts, and photos are frequently attached to walls to provide a decorative perspective to a particular space. Commonly, objects are hung through non-removable, non-reusable, and/or damaging techniques. For example, a screw may secure a sculpture on a wall by extending through the sculpture and the wall. Attachment techniques such as screwing the object directly onto the wall can damage the object. In another example, paintings include a non-removable hanging wire to support the weight of the painting when hung from the wall.

Therefore, there is a long-felt but unresolved need for a system or method that facilitates hanging objects to vertical surfaces without damaging the object, is reusable, and can be removed from the particular object being hung.

### BRIEF SUMMARY OF THE DISCLOSURE

Briefly described, and according to one embodiment, aspects of the present disclosure generally relate to devices, articles, apparatuses, systems, and methods for affixing objects to a wall.

In various embodiments, a wall mounting device can enable securing objects onto any particular wall. The wall mounting device can attach to a particular object using any adhesive material and/or substance. The particular object may include, but is not limited to, a painting frame, a picture frame, a sculpture, a display, an artifact, a natural substance, and a poster. The wall mounting device can include a second aperture that receives a screw extending from the wall. For example, the screw, nail, pin, and/or any rigid material can extend from to the wall. Continuing this example, the wall mounting device can receive and hang from the screw to secure in place the object adhered to the wall mounting device. By hanging from the screw, the wall mounting device can suspend from the desired wall or surface and support the weight of the particular object.

The wall mounting device can be manufactured from natural materials or synthetic compounds. For example, the wall mounting device can be made from plastic, wood, and/or any other rigid substance. In one or more embodiments, the wall mounting device is adhered to the particular object using any suitable type of adhesive. For example, adhesive materials can include double-sided tape, 3M command adhesives, glue, tape, and/or any other adhesive material that supports the weight of the object. In some embodiments, an elongated shape in the wall mounting device can include a first semicircle and a second semicircle that are connected by two parallel sides. In various embodiments, the second semicircle has a larger diameter than the first semicircle. The larger diameter of the second semicircle as compared to the first semicircle can facilitate inserting the head of the screw, nail, and/or pin into the wall mounting device. The smaller diameter of the first semicircle as compared to the second semicircle can facilitate locking the head of the screw, nail, and/or pin within the wall mounting device.

In at least one or more embodiments, the screw is inserted into the wall and/or any desired surface. Once the screw is drilled into the wall, the wall mounting device can be adhered to the particular object. In some embodiments, the wall mounting device can be adhered to the particular object before inserting the screw into the wall. Once the wall mounting device is adhered to the particular object, the head of the screw can be placed into the second semicircle of the wall mounting device. By placing the head of the screw into the wall mounting device, the head of the screw can slide up the wall mounting device through the two sides of the elongated shape. Once the screw has progressed completely through the elongated shape, the second semicircle of the wall mounting device can rest on the screw and hang from the wall.

According to a first aspect, a wall mounting apparatus, comprising: A) a first prism comprising a first surface and a second surface, the first surface being parallel to the second surface; B) a first aperture in the first prism extending through the first surface and the second surface, the first aperture comprising a semicircular arch; C) a second prism comprising a third surface and a fourth surface, the third surface being parallel the fourth surface and the fourth surface configured to mount to the first surface; and D) a second aperture in the second prism extending through the third surface and the fourth surface, the second aperture comprising an elongated shape configured to form a locking interface.

According to a further aspect, the wall mounting apparatus of the first aspect or any other aspect, wherein a first width of the first prism is larger than a second width of the second prism, and a first length of the first prism is equal to a second length of the second prism.

According to a further aspect, the wall mounting apparatus of the first aspect or any other aspect, wherein the second surface of the first prism is configured to couple to an object via a double sided adhesive, wherein a first side of the double sided adhesive appends to the second surface of the first prism and a second side of the double sided adhesive is configured to append to the object.

According to a further aspect, the wall mounting apparatus of the first aspect or any other aspect, wherein the first prism and the second prism comprise rectangular prisms.

According to a further aspect, the wall mounting apparatus of the first aspect or any other aspect, wherein the elongated shape comprises a first semicircle with a first diameter and a second semicircle with a second diameter greater than the first diameter.

According to a further aspect, the wall mounting apparatus of the first aspect or any other aspect, wherein the elongated shape comprises a pair of parallel lines extending tangentially from two endpoints of the first semicircle to intersect with the second semicircle, wherein the two endpoints are the first diameter apart.

According to a further aspect, the wall mounting apparatus of the first aspect or any other aspect, wherein the first aperture is aligned with the second aperture.

According to a further aspect, the wall mounting apparatus of the first aspect or any other aspect, wherein the second aperture fits within an outline of the first aperture along a plane parallel to the first surface and the second surface.

According to a further aspect, the wall mounting apparatus of the first aspect or any other aspect, wherein the elongated shape further comprises: A) a semicircle arch at a first side of the elongated shape; and B) a plurality of teeth extending from a first edge of the semicircular arch.

According to a second aspect, a wall mounting system, comprising: A) a base comprising: 1) a first prism comprising a first surface and a second surface, the first surface being parallel to the second surface; 2) a first aperture in the first prism extending through the first surface and the second surface, the first aperture comprising a semicircular arch; 3) a second prism comprising a third surface and a fourth surface, the third surface being parallel the fourth surface and the fourth surface configured to mount to the first surface; and 4) a second aperture in the second prism extending through the third surface and the fourth surface, the second aperture comprising an elongated shape configured to form a locking interface; and B)an adhesive comprising a first side appended to the second surface of the first prism and a second side configured to append to an object.

According to a further aspect, the wall mounting system of the second aspect or any other aspect, wherein the adhesive comprises at least one of: an epoxy, a double sided tape, or a glue.

According to a further aspect, the wall mounting system of the second aspect or any other aspect, wherein the first prism and the second prism are injection molded to form the base.

According to a further aspect, the wall mounting system of the second aspect or any other aspect, wherein a first width of the first prism is larger than a second width of the second prism, and a first length of the first prism is equal to a second length of the second prism.

According to a further aspect, the wall mounting system of the second aspect or any other aspect, wherein the adhesive is parallel to the first surface, the second surface, the third surface, and the fourth surface.

According to a further aspect, the wall mounting system of the second aspect or any other aspect, wherein the elongated shape comprises a first semicircle with a first diameter and a second semicircle with a second diameter greater than the first diameter.

According to a third aspect, a method, comprising: A) applying a first side of an adhesive to a second surface of a first prism of a wall mounting apparatus opposite and parallel to a first surface of the first prism; B) applying a second side of the adhesive to an object; C) inserting a rigid material affixed to a wall through a second aperture in a second prism extending through a third surface of the second prism and a fourth surface of the second prism and a first aperture in the first prism extending through the first surface and the second surface; and D) securing the object to the wall by moving the rigid material along an elongated shape of the second aperture toward a locking interface.

According to a further aspect, the method of the third aspect or any other aspect, further comprising injection molding the wall mounting apparatus.

According to a further aspect, the method of the third aspect or any other aspect, further comprising inserting a first end of the rigid material into the wall prior to inserting a second end of the rigid material through the first aperture and the second aperture.

According to a further aspect, the method of the third aspect or any other aspect, further comprising: A) lifting the object vertically relative to the rigid material; and B) pulling the object horizontally away from the wall to withdraw the rigid material through the first aperture and the second aperture to remove the object from the wall.

According to a further aspect, the method of the third aspect or any other aspect, wherein the first prism and the second prism comprise cylindrical prisms.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1A illustrates a perspective view of a first wall mounting device, according to one embodiment of the present disclosure;

FIG. 1B illustrates a top view of the first wall mounting device, according to one embodiment of the present disclosure;

FIG. 2A illustrates a front view of the first wall mounting device, according to one embodiment of the present disclosure;

FIG. 2B illustrates a side view of the first wall mounting device, according to one embodiment of the present disclosure;

FIG. 2C illustrates a back view of the first wall mounting device, according to one embodiment of the present disclosure;

FIG. 3 illustrates a perspective view of a second wall mounting device, according to one embodiment of the present disclosure;

FIG. 4A illustrates a top view of the second wall mounting device, according to one embodiment of the present disclosure;

FIG. 4B illustrates a front view of the second wall mounting device, according to one embodiment of the present disclosure;

FIG. 5A illustrates a side view of the second wall mounting device, according to one embodiment of the present disclosure;

FIG. 5B illustrates a back view of the second wall mounting device, according to one embodiment of the present disclosure;

FIGS. 6A-C illustrates various wall mounting devices, according to one embodiment of the present disclosure;

FIG. 7 illustrates an object with an installed second wall mounting device, according to one embodiment of the present disclosure;

FIG. 8, illustrates an object with an installed first wall mounting device, according to one embodiment of the present disclosure; and

FIG. 9 illustrates a flowchart of a process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

Overview

Aspects of the present disclosure generally relate to affixing an object to a wall. In various embodiments, the wall mounting device can attach to a particular object using any adhesive or securing mechanism. For example, the wall mounting device can attach to the object through the use of a double sided adhesive material. In one or more embodiments, the particular objects can include, but are not limited to, painting frames, picture frames, sculptures, displays, artifacts, natural substances, and posters. The wall mounting device can connect with a screw, nail, clip, and/or any other rigid material extending from the wall. The wall mounting device can hold the object in place on the wall by hanging from the screw, nail, clip, and/or any other rigid material. In particular embodiments, the screw can be attached to the wall and/or pass through the wall. The screw can puncture the wall and grapple to any particular material and/or substance within the wall. The screw can include an expansion component that may engage within an interior surface of the wall once inserted. In various embodiments, the expansion component can prevent the screw from extruding out of the wall.

The wall mounting device can hang from the screw, nail, and/or rigid material. By hanging from the rigid material, the wall mounting device can be affixed to the desired wall or surface at a predefined position. The wall mounting device can be manufactured from natural materials or synthetic compounds. For example, the wall mounting device can be made from plastic, wood, and/or any other rigid substance. The wall mounting device can be manufactured using a lathe, CNC machine, injection molding system, additive manufacturing system, compression molding system, and/or any other appropriate manufacturing system. In one or more embodiments, the wall mounting device is adhered to the object being mounted using any suitable type of adhesive. For example, adhesive materials can include 3M double-sided tape, 3M command adhesives, glue, and/or any other adhesive material that supports the weight of the particular object. The wall mounting device can have a second aperture that receives the head of a screw. In at least one embodiment, the second aperture may include a channel that secures around the head of the screw, locking into place the wall mounting device and the appended object.

In at least one or more embodiments, the screw is inserted into the wall and/or any desired surface. Once the screw is drilled into the wall, the wall mounting device can be adhered to the particular object. In some embodiments, the wall mounting device can be adhered to the particular object before inserting the screw into the wall. Once the wall mounting device is adhered to the particular object, the head of the screw can be placed into the wall mounting device. By placing the screw-head into the wall mounting device, the screw-head can slide up the wall mounting device through the two sides of the second aperture. Once the screw has progressed completely through the locking interface, the wall mounting device can rest on the screw and hang from the wall.

Exemplary Embodiments

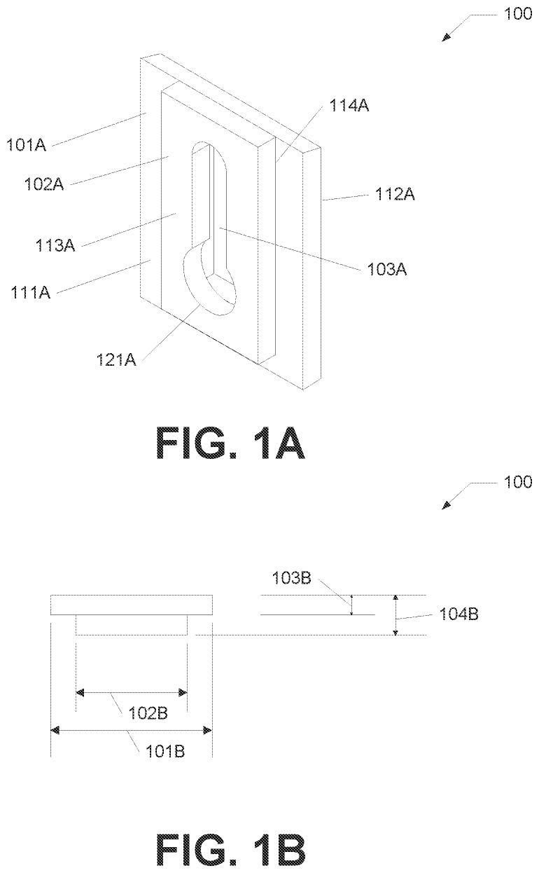

Referring now to the figures, for the purposes of example and explanation of the fundamental processes and components of the disclosed systems and processes, reference is made to FIG. 1A, which illustrates a first wall mounting device 100 of one embodiment of the present disclosure. As will be understood and appreciated, the first wall mounting device 100 shown in FIG. 1A represents merely one approach or embodiment of the present system, and other aspects are used according to various embodiments of the present system.

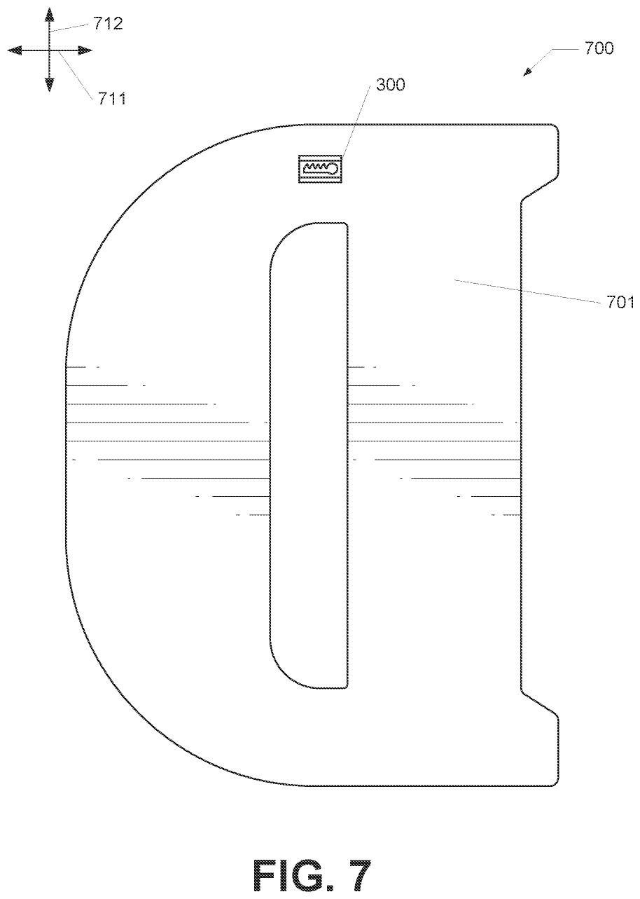

The first wall mounting device 100 can attach an object 701 (see FIG. 7) onto a particular wall or surface. The first wall mounting device 100 can attach to the object 701 and can hang from a screw, nail, and/or any rigid material that fits in the first wall mounting device 100. The first wall mounting device 100 can secure onto the object 701 and facilitate hanging or removing the object 701 from the wall. The first wall mounting device 100 can be removed from the wall without removing the rigid material. As such, holiday decorations may be quickly hung during a particular holiday season and removed after the holiday season leaving only the rigid material extending from the wall.

In some embodiments, the first wall mounting device 100 is manufactured using any particular rigid substance. Rigid substances can include, but are not limited to, woods, plastics, polymers, or synthetic fibers. In various embodiments, the rigid substances used to construct the first wall mounting device 100 are selected based on the particular appending technique to the object 701. For example, a plastic first wall mounting device 100 may provide a greater hold than a metal first wall mounting device 100 when using a particular glue to append the plastic first wall mounting device 100 to the object 701. In another example, a different epoxy type may provide a greater hold for the metal first wall mounting device 100 as compared to the plastic first wall mounting device 100. The first wall mounting device 100 can be manufactured using conventional wood working techniques, 3-D printing, injection molding, compression molding, CNC machining or other material removal processes, and any other suitable manufacturing technique.

The first wall mounting device 100 can include a first prism 101A and a second prism 102A. The second prism 102A can affix to the rigid material extending from the wall (e.g., screw, pin, nail). The first prism 101A can append to the object 701. The first prism 101A can include a first surface 111A and a second surface 112A. The second prism 102A can include a third surface 113A and a fourth surface 114A. The first prism 101A and the second prism 102A can be manufactured as one component or as individual components. For example, if manufactured separately, the fourth surface 114A of the second prism 102A can connect to the first surface 111A of the first prism 101A through an epoxy, glue, and/or any suitable adhesive. In another example, the first prism 101A and the second prism 102A are constructed as one continuous component using a 3-D printer, an injection molding system, and/or a compression molding system. The combination of the first prism 101A and the second prism 102A can be referred to as a base. In at least one embodiment, the first prism 101A and the second prism 102A can couple by heating and joining the first surface 111A to the fourth surface 114A, and vise-versa. In particular embodiments, a metal second prism 102A can be welded onto a metal first prism 101A.

In at least one embodiment, the first surface 111A and the second surface 112A are parallel. The third surface 113A can be parallel to the fourth surface 114A. In some embodiments, the first surface 111A is parallel to the fourth surface 114A. The third surface 113A can be flat, curved, angled, concave, convex, and/or any other particular shape configuration based on the needs of the particular wall and object 701. For example, if the wall is angled inwards (e.g., the wall and the floor make an angle less than 90 degrees), the third surface 113A can be parallel to the angled wall. Continuing this example, the object 701 may hang from the wall at an angle parallel to the wall. In some embodiments, the first surface 111A, the second surface 112A, and the fourth surface 114A are parallel, while the third surface 113A is not parallel to the first surface 111A. The first prism 101A and the second prism 102A can form a rectangular shape. The first prism 101A and the second prism 102A can form any particular three dimensional shape. For example, the first prism 101A and the second prism 102A can be circular, cylindrical, square, rectangular, trapezoidal, and/or triangular.

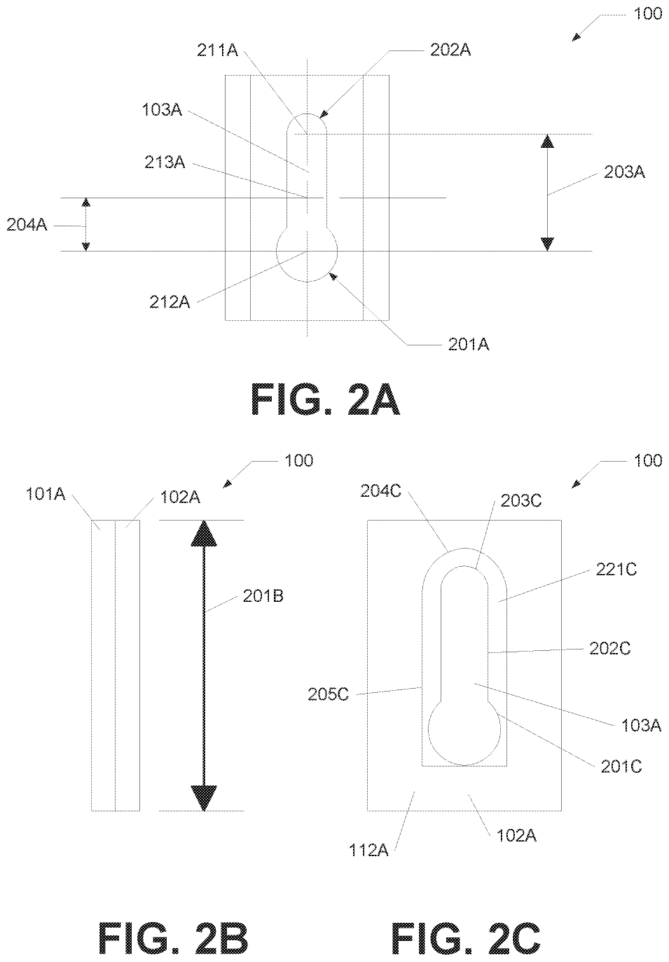

The second prism 102A can include a second aperture 103A. In particular embodiments, the second aperture 103A can receive the rigid material (e.g., the screw, nail, and/or bolt). The rigid material can hold the first wall mounting device 100 at a fixed location. The second aperture 103A can extend through the third surface 113A and the fourth surface 114A. The second aperture 103A can include an elongated shape 121A. The elongated shape 121A can function as a locking interface between the first wall mounting device 100 and the rigid material extending from the wall. In some embodiments, the elongated shape 121A of the second aperture 103A is discussed in further detail herein (see FIGS. 2A-C).

The rigid material can include, but is not limited to, a nail, a screw, clip, and/or a bolt. In some embodiments, the rigid material includes a head that enters the second aperture 103A and slides up into a locked position. As the second aperture 103A becomes narrower and the rigid material enters the narrower portion of the second aperture 103A, the narrower portion of the second aperture 103A keeps the head of the screw from detaching from the first wall mounting device 100. In some embodiments, when assembled, the second aperture 103A can envelope around the head of the screw and can secure the object 701 onto the particular wall.

Referring now to FIG. 1B, illustrated is a top view of the first wall mounting device 100, according to one embodiment of the present disclosure. The first wall mounting device 100 can include a first width 101B and a second width 102B. The first width 101B can be larger than the second width 102B. In some embodiments, the first width 101B is equal to or smaller than the second width 102B. In one embodiment, the first width 101B can measure at least 0.5 inches, 0.5-4.0 inches, 0.5-2.0 inches, 2.0-4.0 inches, or less than 4 inches. In one embodiment, the second width 102B can measure at least 0.1 inches, 0.1-2.0 inches, 0.1-1.0 inches, 1.0-2.0 inches, or less than 2.0 inches. The first wall mounting device 100 can include a first depth 103B and a total depth 104B. In one embodiment, the first depth 103B can correspond to the depth of the first prism 101A. The first depth 103B can measure at least 0.1 inches, 0.1-1.0 inches, 0.1-0.5 inches, 0.5-1.0 inches, or less than 1.0 inch. In various embodiments, the total depth 104B corresponds to the depth of the first wall mounting device 100. The total depth 104B can measure at least 0.1 inches, 0.1-1.5 inches, 0.1-0.5 inches, 0.5-1.0 inches, 1.0-1.5 inches, or less than 1.5 inches. The size of the total depth 104B can be chosen based on the depth of the head of the rigid material. In some embodiments, the head of the rigid material requires a particular amount of space to move within the first wall mounting device 100. For example, the total depth 104B may be selected as 0.5 inches to accept a screw with a head depth of 0.3 inches.

Referring now to FIG. 2A, illustrated is a front view of the first wall mounting device 100, according to one embodiment of the present disclosure. The second aperture 103A of the first wall mounting device 100 can include a center point 211A, a second center point 212A, and a third center point 213A. The third center point 213A can be located at the center of the first wall mounting device 100. The second center point 212A can be located at the center of a second semicircle 201C (See FIG. 2C). The center point 211A can be located at the center of a first semicircle 203C (see FIG. 2C). The first wall mounting device 100 can include a first length 203A and a second length 204A. The first length 203A can measure the distance between the center point 211A to the second center point 212A. The second length 204A can measure the distance between the second center point 212A and the third center point 213A. In some embodiments, the first length 203A measures at least 0.1 inches, 0.1-1.0 inches, 0.1-0.5 inches, 0.5-1.0 inches, or less than 1.0 inches. In various embodiments, the second length 204A measures at least 0.1 inches, 0.1-1.0 inches, 0.1-0.5 inches, 0.5-1.0 inches, or less than 1.0 inches. The second semicircle 201C can include a first radius 201A and the first semicircle 203C can include a second radius 202A. In at least one or more embodiments, the first radius 201A is larger than the second radius 202A. The first radius 201A allows the first wall mounting device 100 to accept the head of a rigid material, while the second radius 202A hold the rigid material in place. The first radius 201A can measure 0.05-0.2 inches. The second radius 202A can measure 0.025-0.35 inches. In at least one embodiment, the first semicircle 203C can include a first diameter that is smaller than a second diameter of the second semicircle 201C.

In particular embodiments, the head of the screw includes a radius smaller than the first radius 201A. When the head of the screw includes a radius smaller than the first radius 201A, the head of the screw may be inserted into the second semicircle 201C. For example, the head of the screw may be inserted at the second center point 212A.

Referring now to FIG. 2B, illustrated is a side view of the first wall mounting device 100, according to one embodiment of the present disclosure. The first wall mounting device 100 can include a total length 201B. The total length 201B may define the length of a second length of the second prism 102A and a first length of the first prism 101A. The total length 201B can measure 1.0-2.0 inches. The total length 201B can be equal to the first length of the first prism 101A and the second length of the second prism 102A.

Referring now to FIG. 2C, illustrated is a back view of the first wall mounting device 100, according to one embodiment of the present disclosure. The first prism 101A of the first wall mounting device 100 can include the second surface 112A. The second surface 112A can correspond to the back surface of the first prism 101A. The second surface 112A can include a first aperture 221C. The first aperture 221C can include a rectangular shape 205C and an arc 204C. In various embodiments, the rectangular shape 205C and the arc 204C are one continuous edge. In at least one embodiment, the combination of the rectangular shape 205C and the arc 204C forms a semicircular arch. The first aperture can extend through the first surface 111A and the second surface 112A. The width, depth, and height of the first aperture 221C can be large enough to accept the head of the rigid material.

The second aperture 103A can include the second semicircle 201C, a neck 202C, and the first semicircle 203C. The second semicircle 201C, the neck 202C, and the first semicircle 203C can form one continuous edge. In various embodiments, the combination of the second semicircle 201C, the neck 202C, and the first semicircle 203C may form the elongated shape. The neck 202C can include two parallel lines extending from the first semicircle 203C to the second semicircle 201C. For example, the two parallel lines can extend from two endpoints of the first semicircle 203C. The width of the neck 202C can be equal to the diameter of the first semicircle 203C. In at least one embodiment, the second aperture 103A and the first aperture 221C can form one continuous aperture extending through the second surface 112A and the third surface 113A. The first aperture 221C and the second aperture 103A may be aligned. For example, the outline of the second aperture 103A can fit within the outline of the first aperture 221C. In some embodiments, aligning the first aperture 221C and the second aperture 103A facilitates accepting the head of the screw within the first wall mounting device 100.

In particular embodiments, the second surface 112A can append onto the object 701 being hung from the wall or surface. Appending techniques can include, but are not limited to, glue, epoxy, bonding putty, touch fasteners (Velcro), double-sided tape, or any other suitable appending technique. The second surface 112A can be sanded to increase the stick between the first wall mounting device 100 and the object 701. A double sided adhesive may be applied to the first wall mounting device 100 and the object 701. For example, a first side of the double sided adhesive may append to the second surface 112A of the first wall mounting device 100. Continuing this example, a second side of the double sided adhesive may be applied to the object 701. In some embodiments, the double sided adhesive locks the second surface 112A of the first wall mounting device 100 onto the object 701. The adhesive may be applied to the first wall mounting device 100 parallel to the first surface 111A, the second surface 112A, the third surface 113A, and/or the fourth surface 114A.

In a typical use case scenario, once the first wall mounting device 100 has been appended to the object 701, the second semicircle 201C can accept the head of the rigid material (e.g., screw, nail, bolt). Once the head of the rigid material has been inserted into the second semicircle 201C, the object 701 can be moved toward the first semicircle 203C (e.g., using gravity). As the object 701 is lowered or moved, the rigid material progresses toward the second aperture 103A through the neck 202C. The diameter of the neck 202C and/or the radius 202A of the first semicircle 203C may be selected to be smaller than the diameter and/or radius of the head of the rigid material. Selecting a diameter and/or radius of the first semicircle 203C smaller than the diameter and/or radius of the head of the screw may allow the neck 202C and the first semicircle 203C to lock the head of the screw within the first wall mounting device 100. Once the rigid material reaches the first semicircle 203C, the interior surface of first semicircle 203C can rest on a shank of the rigid material. The shank of the rigid material can be defined as the section of a screw between the threads and the head. Once centered, the object 701 can hang from the rigid material attached to the wall or surface through the first wall mounting device 100.

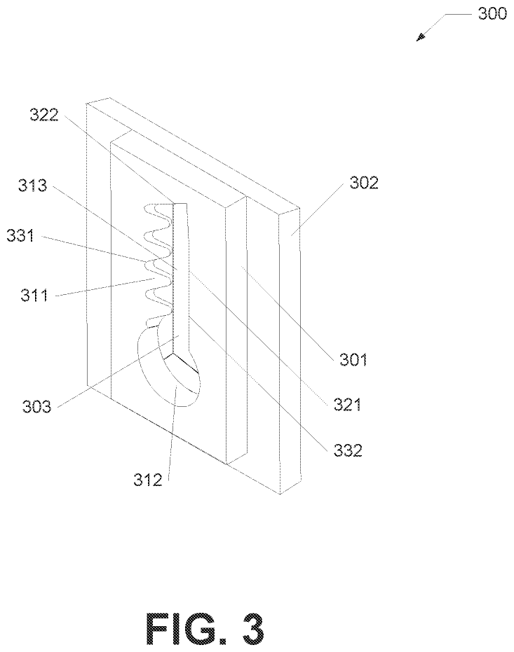

Referring now to FIG. 3, illustrated is a second wall mounting device 300, according to one embodiment of the present disclosure. The second wall mounting device 300 can include a second prism 301 and a first prism 302. In some embodiments, the second prism 301 and the first prism 302 are substantially similar to the second prism 102A and the first prism 101A, respectively. In some embodiments, the second prism 102A includes a second aperture 303. The second aperture 303 can accept the head of the rigid material.

In particular embodiments, the second aperture 303 forms an elongated shape. The elongated shape of the second aperture 303 can be substantially similar to a key. The second aperture 303 can include at least one teeth 311, a first semicircle 312, and a semicircular arch 313. The semicircular arch 313 can include a neck 321 and a top surface 322. The top surface 322 can represent the first side of the second aperture. In some embodiments, the top surface 322 can be rounded in the shape of a semicircle or can be a linear surface. The neck 321 can include a first edge 331 and a second edge 332. The second edge 332 can include a linear surface extending from the top surface 322 to the first semicircle 312. The first edge 331 can include a jagged edge extending from the top surface 322 to the first semicircle 312. The series of teeth 311 can extend from the first edge 331. The semicircular arch 313 and the first semicircle 312 can form one continuous edge connecting. The teeth 311 can accept the shank of the screw when hanging the object 701. For example, when the head of the screw is placed into the arch of semicircular 312, the second wall mounting device 300 can use the teeth 311 to hang from the screw. The teeth 311 can be angled such that the second wall mounting device 300 envelopes the rigid material and hangs from the wall or surface.

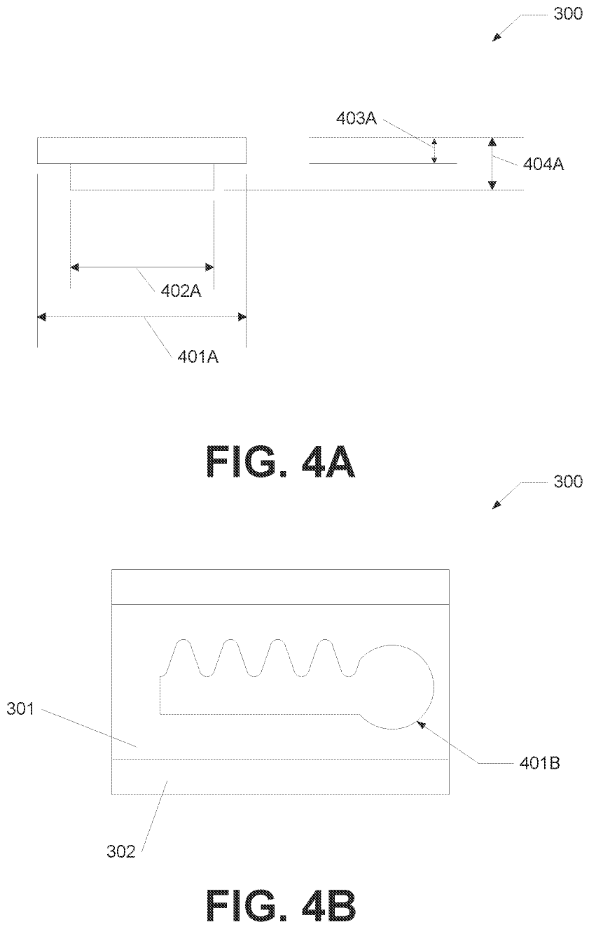

Referring now to FIG. 4A, illustrated is a top view of the second wall mounting device 300, according to one embodiment of the present disclosure. The second wall mounting device 300 can include a first width 401A and a second width 402A. In come embodiments, the first width 401A and the second width 402A are substantially similar to the first width 101B and the second width 102B, respectively. The second wall mounting device 300 can include a first depth 403A and a total depth 404A. In at least one embodiment, the first depth 403A and the total depth 404A are substantially similar to the first depth 103B and the total depth 104B, respectively.

Referring now to FIG. 4B, illustrated is a front view of the second wall mounting device 300, according to one embodiment of the present disclosure. The second wall mounting device 300 can include a radius 401B. In some embodiments, the radius 401B of the second wall mounting device 300 is substantially similar to the radius 201A of the first wall mounting device 100.

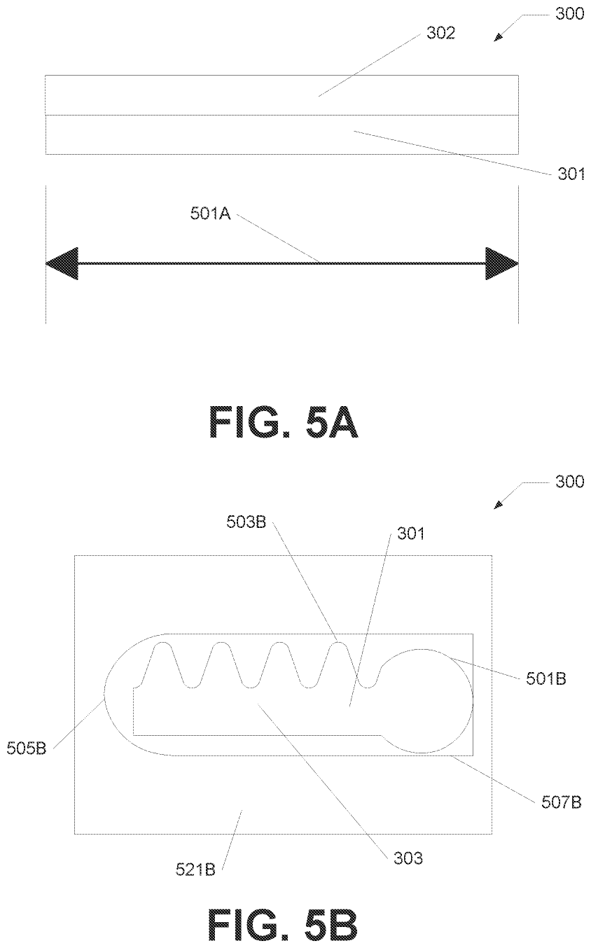

Referring now to FIG. 5A, illustrated is a side view of the second wall mounting device 300, according to one embodiment of the present disclosure. The second wall mounting device 300 can include a total length 501A that measure the length of the second prism 301 and the first prism 302. The total length 501A of the second wall mounting device 300 can be substantially similar to the total length 201B of the first wall mounting device 100.

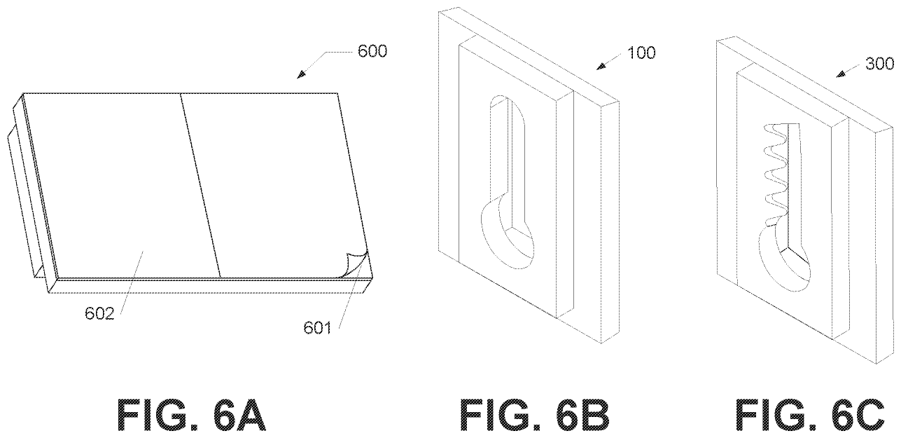

Referring now to FIG. 5B, illustrated is a back view of the second wall mounting device 300, according to one embodiment of the present disclosure. The second wall mounting device 300 can include the first semicircle 312, the second aperture 303, a rectangular shape 507B, and an arc 505B. The rectangular shape 507A and the arc 505B can be a continuous edge. The rectangular shape 507B and the arc 505B are substantially similar to the rectangular shape 205C and the arc 204C, respectively. The second aperture 303 can include at least one inlet 503B. The inlet 503B can accept the shank of the rigid material to lock the second wall mounting device 300 at predefined locations. Similar to the first wall mounting device 100, the second aperture 303 of the second wall mounting device 300 can accept the head of the rigid material. For example, the first end of the rigid material (e.g., screw) is inserted in the wall. Continuing this example, the second wall mounting device 300 can be appended to the object 701 similarly to the first wall mounting device 100. Further continuing this example, once the second wall mounting device 300 is appended to the object 701, a second end (e.g., head) of the rigid material may be inserted into the first semicircle 312. After setting the object 701 on the rigid material, the second wall mounting device 300 can append the object 701 to the wall or surface. The second wall mounting device 300 can include a back surface 521B. The back surface 521B may be substantially similar to the second surface 112A of the first wall mounting device 100. The back surface 521B can accept any particular adhesive material 601 to attach onto the surface of the object 701 being hung. The adhesive materials 601 can include gluing, touch fasteners (Velcro), double-sided tape, or any other suitable appending material (see FIG. 6A).

Referring now to FIGS. 6A-C, illustrated are wall mounting devices 100, 300, and 600, according to one embodiment of the present disclosure. A third wall mounting device 600 may be the first wall mounting device 100 and/or the second wall mounting device 300 with an adhesive material 601. The first wall mounting device 100 and the second wall mounting device 300 can include the adhesive material 601. For example, the adhesive material 601 can include double-sided tape. The adhesive material 601 can be applied to the first wall mounting device 100 and/or the second wall mounting device 300 to attach to the object 701. For example, a first side of the adhesive material 601 may be applied to the second surface 112A of the first wall mounting device 100. Continuing this example, a second side of the adhesive material may be applied to the object 701. The adhesive material 601 may include a protective sticker 602 that may be removed to expose the second side of the adhesive material 601.

Referring now to FIG. 7, illustrated is an object 701 with an installed second wall mounting device 300, according to one embodiment of the present disclosure. The object 701 can be any particular item that can be hung on a wall or surface. In various embodiments, the second wall mounting device 300 appends to the object 701. The second wall mounting device 300 can be designed proportional to the size and weight of the object 701. The second wall mounting device 300 can append to the object 701 by using an adhesive material 601. Other forms of appending techniques can be used to append the second wall mounting device 300 to the object 701. In various embodiments, a wall mounting configuration 700 may include a first axis 711 and a second axis 712.

The second wall mounting device 300 may be angled such that the length of the elongated shape 121A extends parallel to the first axis 711. In particular embodiments, angling the elongated shape 121A parallel to the first axis 711 facilitates allowing the shank of the rigid material to nestle between two adjacent teeth 311. The second wall mounting device 300 may be positioned on the object 701 at any particular angle relative to the first axis 711 and the second axis 712. For example, the second wall mounting device 300 may be positioned such that the elongated shape extends at a 45 degree angle from the first axis 711.

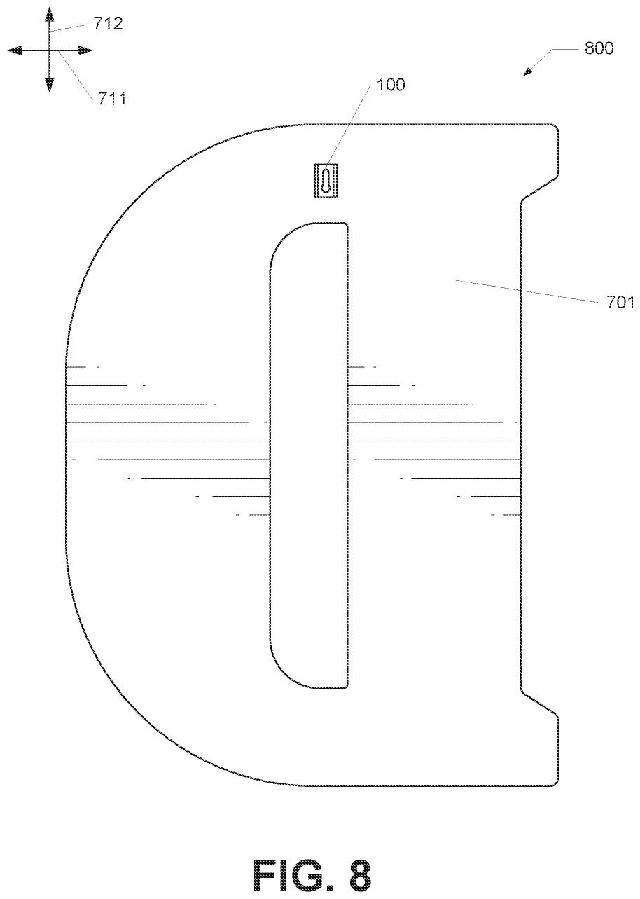

Referring now to FIG. 8, illustrated is the object 701 with an installed first wall mounting device 100, according to one embodiment of the present disclosure. A second wall mounting configuration 800 may demonstrate the first wall mounting device 100 attached to the object 701. In various embodiments, the first wall mounting device 100 appends to the object 701 parallel to the second axis 712. In at least one embodiment, the second axis 712 extends from a ceiling of a room to a floor of a room, where a wall divides the ceiling and the floor and is perpendicular to both the ceiling and the floor. In at least one embodiment, the second axis 712 extends perpendicularly to the direction of gravity. The first wall mounting device 100 can be designed proportional to the size and weight of the object 701. The first wall mounting device 100 can append to the object 701 by using an adhesive material 601. Other forms of appending techniques can be used to append the first wall mounting device 100 to the object 701. The second wall mounting device 300 may be positioned on the object 701 at any particular angle relative to the first axis 711 and the second axis 712. For example, the second wall mounting device 300 may be positioned such that the elongated shape extends at a 45 degree angle from the first axis 711.

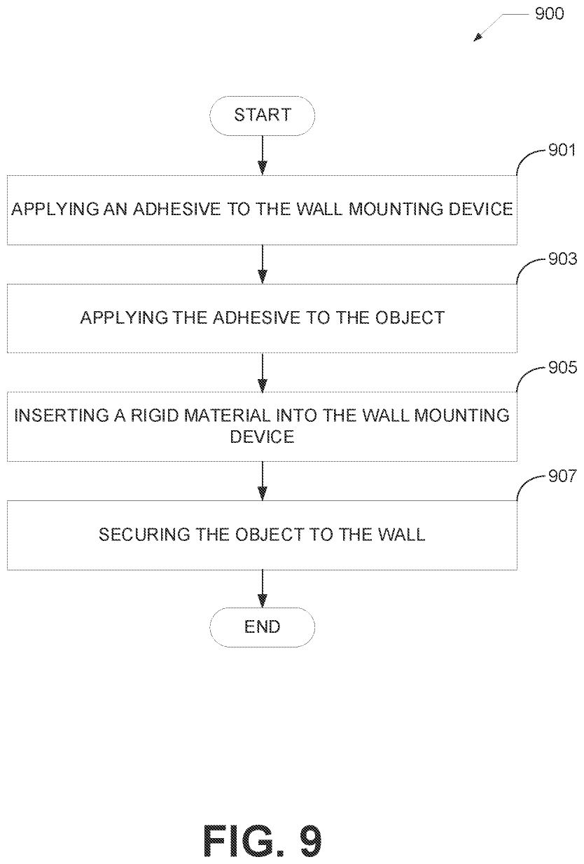

Referring now to FIG. 9, illustrated is a flowchart of a process 900, according to one embodiment of the present disclosure. In various embodiments, the particular blocks of the process 900 may be performed in any particular order. The process 900 may illustrate a method for mounting an object 701 onto a wall or surface using the first wall mounting device 100, the second wall mounting device 300, and/or any particular variation of the wall mounting device.

Referring to box 901, the process 900 may include applying the adhesive material 601 to the first wall mounting device 100. In some embodiments, the adhesive material 601 can be a double sided material. The adhesive material 601 can include the first side and the second side. In certain embodiments, the first side of the adhesive material 601 is applied to the second surface 112A of the first wall mounting device 100. The adhesive material 601 may connect to the second surface 112A of the first prism 101A, which may be opposite and parallel to the first surface 111A of the first prism 101A. The adhesive material 601 can be any suitable adhesive that can support the weight of the object 701 when attached to the first wall mounting device 100. The first side of the adhesive material 601 can be applied to the first wall mounting device 100 during manufacturing. For example, the first wall mounting device 100 can be sold with the first side of the adhesive material 601 applied to the first wall mounting device 100.

Referring now to box 903, the process 900 can include applying the adhesive material 601 to the object 701. In various embodiments, the second side of the adhesive material 601 is covered by the protective sticker 602. The protective sticker 602 can maintain the adhesive capabilities of the second side of the adhesive material 601. The protective sticker 602 can be removed before the first wall mounting device 100 is applied to the object 701. Once the protective sticker 602 is removed from the adhesive material 601, the second side of the adhesive material 601 may be exposed. The second side of the adhesive material 601 can be applied to the object 701. The first wall mounting device 100 can be attached to any particular location of the object 701. In various embodiments, the first wall mounting device 100 is placed at a balanced position on the object 701 such that the object 701 does not pivot once hung from the rigid material.

Referring now to box 905, the process 900 can include inserting the rigid material (e.g., screw, nail, bolt) into the first wall mounting device 100. In some embodiments, the rigid material affixes to a wall or surface. The rigid material may extend from the wall. For example, a first end of a screw may be inserted into the wall exposing a second end (e.g., head) of the rigid material and the shank of the rigid material. The rigid material may be inserted into the wall prior to inserting the head of the rigid material into the second semicircle of the second aperture 103A. The second semicircle 201C of the second aperture 103A may accept the head of the rigid material. As the head of the rigid material extends through the second aperture 103A of the second prism 102A, the head of the rigid material may extend through the first aperture 221C of the first prism 101A.

Referring now to box 907, the process 900 can include securing the object 701 to the wall. Relative to the rigid material, the object 701 may be lowered such that the head of the rigid material moves from the second semicircle 201C to the first semicircle 203C through the neck 202C. For example, the head of the rigid material may move through the elongated shape 121A into a locked position. As the object 701 is lowered or positioned onto the rigid material, the interior surface of the first semicircle 203C may rest on the shank of the rigid material. The radius 202A of the first semicircle 203C may be smaller than the radius of the head of the rigid material. Selecting the radius 202A of the first semicircle 203C smaller than the head of the rigid material may form a locking interface between the first wall mounting device 100 and the head of the rigid material. The force of gravity due to the object 701 may transition into the first wall mounting device 100 and the adhesive material 601. The first wall mounting device 100 may counteract the force of gravity exerted by the object 701 by producing an opposite normal force between the rigid material and the interior surface of the first semicircle 203C. By canceling the force of gravity exerted by the object 701, the first wall mounting device 100 may hold the object 701 at the particular location on the wall. For example, the first wall mounting device 100 may support the weight of the object 701 by exerting the weight on the rigid material. In at least one embodiment, the first wall mounting device 100 may hold the object 701 on the wall for any particular amount of time.

In at least one embodiment, reverse actions compared to boxes 907 and 905 may be performed when removing the object 701 from the wall or surface. For example, the object 701 may be lifted vertically relative to the rigid material to disengage the locking interface between the rigid material and the first wall mounting device 100. The object 701 may be moved vertically relative to the rigid material such that the head of the rigid material moves form the first semicircle 203C to the second semicircle 201C. For example, the head of the rigid material can move through the elongated shape 121A. In particular embodiments, the object 701 is pulled horizontally away from the wall to withdraw the rigid material from the first aperture 221C and the second aperture 103A. Moving the head of the rigid material out of the second semicircle 201C may facilitate removing the object 701 from the wall.

The foregoing description of the exemplary embodiments has been presented only for the purposes of illustration and description and is not intended to be exhaustive or to limit the inventions to the precise forms disclosed. Many modifications and variations are possible in light of the above teaching.

The embodiments were chosen and described in order to explain the principles of the inventions and their practical application so as to enable others skilled in the art to utilize the inventions and various embodiments and with various modifications as are suited to the particular use contemplated. Alternative embodiments will become apparent to those skilled in the art to which the present inventions pertain without departing from their spirit and scope.

What is claimed is:

1. A wall mounting apparatus, comprising:
a first prism comprising a first surface and a second surface, the first surface being parallel to the second surface;
a first aperture in the first prism extending through the first surface and the second surface, the first aperture comprising a semicircular arch;
a second prism comprising a third surface and a fourth surface, the third surface being parallel the fourth surface and the fourth surface configured to mount to the first surface; and
a second aperture in the second prism extending through the third surface and the fourth surface, the second aperture comprising an elongated shape configured to form a locking interface.

2. The wall mounting apparatus of claim 1, wherein a first width of the first prism is larger than a second width of the second prism, and a first length of the first prism is equal to a second length of the second prism.

3. The wall mounting apparatus of claim 1, wherein the second surface of the first prism is configured to couple to an object via a double sided adhesive, wherein a first side of the double sided adhesive appends to the second surface of the first prism and a second side of the double sided adhesive is configured to append to the object.

4. The wall mounting apparatus of claim 1, wherein the first prism and the second prism comprise rectangular prisms.

5. The wall mounting apparatus of claim 1, wherein the elongated shape comprises a first semicircle with a first diameter and a second semicircle with a second diameter greater than the first diameter.

6. The wall mounting apparatus of claim 5, wherein the elongated shape comprises a pair of parallel lines extending tangentially from two endpoints of the first semicircle to intersect with the second semicircle, wherein the two endpoints are the first diameter apart.

7. The wall mounting apparatus of claim 1, wherein the first aperture is aligned with the second aperture.

8. The wall mounting apparatus of claim 1, wherein the second aperture fits within an outline of the first aperture along a plane parallel to the first surface and the second surface.

9. The wall mounting apparatus of claim 1, wherein the elongated shape further comprises:
a semicircle arch at a first side of the elongated shape; and
a plurality of teeth extending from a first edge of the semicircular arch.

10. A wall mounting system, comprising:
a base comprising:
a first prism comprising a first surface and a second surface, the first surface being parallel to the second surface;
a first aperture in the first prism extending through the first surface and the second surface, the first aperture comprising a semicircular arch;
a second prism comprising a third surface and a fourth surface, the third surface being parallel the fourth surface and the fourth surface configured to mount to the first surface; and
a second aperture in the second prism extending through the third surface and the fourth surface, the second aperture comprising an elongated shape configured to form a locking interface; and
an adhesive comprising a first side appended to the second surface of the first prism and a second side configured to append to an object.

11. The wall mounting system of claim 10, wherein the adhesive comprises at least one of: an epoxy, a double sided tape, or a glue.

12. The wall mounting system of claim 10, wherein the first prism and the second prism are injection molded to form the base.

13. The wall mounting system of claim 10, wherein a first width of the first prism is larger than a second width of the second prism, and a first length of the first prism is equal to a second length of the second prism.

14. The wall mounting system of claim 10, wherein the adhesive is parallel to the first surface, the second surface, the third surface, and the fourth surface.

15. The wall mounting system of claim 10, wherein the elongated shape comprises a first semicircle with a first diameter and a second semicircle with a second diameter greater than the first diameter.

16. A method, comprising:
applying a first side of an adhesive to a second surface of a first prism of a wall mounting apparatus opposite and parallel to a first surface of the first prism;
applying a second side of the adhesive to an object;
inserting a rigid material affixed to a wall through a second aperture in a second prism extending through a third surface of the second prism and a fourth surface of the second prism and a first aperture in the first prism extending through the first surface and the second surface; and
securing the object to the wall by moving the rigid material along an elongated shape of the second aperture toward a locking interface.

17. The method of claim 16, further comprising injection molding the wall mounting apparatus.

18. The method of claim 16, further comprising inserting a first end of the rigid material into the wall prior to inserting a second end of the rigid material through the first aperture and the second aperture.

19. The method of claim 16, further comprising:
lifting the object vertically relative to the rigid material; and
pulling the object horizontally away from the wall to withdraw the rigid material through the first aperture and the second aperture to remove the object from the wall.

20. The method of claim 16, wherein the first prism and the second prism comprise cylindrical prisms.
